(19) United States
(12) Patent Application Publication
(10) Pub. No.: US 2013/0271451 A1
(43) Pub. Date: Oct. 17, 2013

(54) PARAMETERIZED 3D FACE GENERATION

(71) Applicants: Xiaofeng Tong, Beijing (CN); Wei Hu, Beijing (CN); Yangzhou Du, Beijing (CN); Yimin Zhang, Beijing (CN)

(72) Inventors: Xiaofeng Tong, Beijing (CN); Wei Hu, Beijing (CN); Yangzhou Du, Beijing (CN); Yimin Zhang, Beijing (CN)

(21) Appl. No.: 13/976,869

(22) PCT Filed: Aug. 9, 2011
(86) PCT No.: PCT/CN2011/001305

§ 371 Date: Jun. 27, 2013

(51) Int. Cl. G06T 17/00

(52) U.S. Cl. CPC G06T 17/00
USPC 345/419

(57) ABSTRACT

Systems, devices and methods are described including receiving a semantic description and associated measurement criteria for a facial control parameter, obtaining principal component analysis (PCA) coefficients, generating 3D faces in response to the PCA coefficients, determining a measurement value for each of the 3D faces based on the measurement criteria, and determining a regression parameters for the facial control parameter based on the measurement values.

### BACKGROUND

modeling of human facial features is commonly used to create realistic 3D representations of people. For instance, virtual human representations such as avatars frequently make use of such models. Some conventional applications for generated facial representations permit users to customize facial features to reflect different facial types, ethnicities and so forth by directly modifying various elements of an underlying 3D model. For example, conventional solutions may allow modification of face shape, texture, gender, age, ethnicity, and the like. However, existing approaches do not allow manipulation of semantic face shapes, or portions thereof in a manner that permits the development of a global 3D facial model.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system;

FIG. 2 illustrates an example process;

FIG. 3 illustrates an example process;

FIG. 4 illustrates an example mean face;

FIG. 5 illustrates an example process;

FIG. 6 illustrates an example user interface;

FIGS. 7, 8, 9 and 10 illustrate example facial control parameter schemes; and

FIG. 11 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

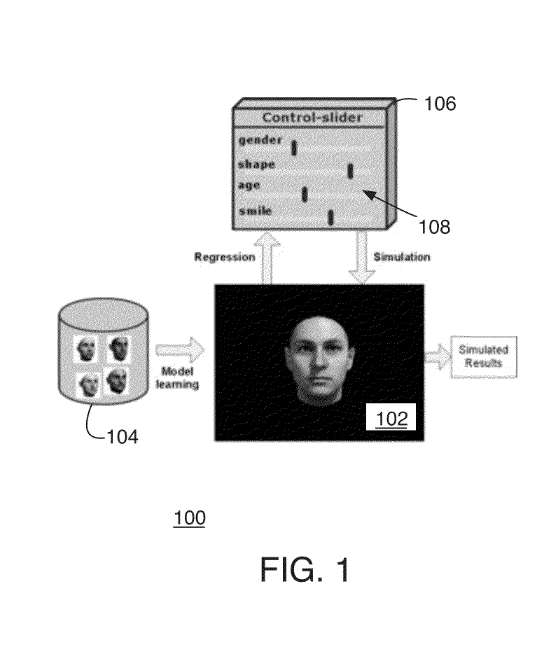

FIG. 1 illustrates an example system 100 in accordance with the present disclosure. In various implementations, system 100 may include a 3D morphable face model 102 capable of parameterized 3D face generation in response to model 3D faces stored in a database 104 of model 3D faces and in response to control data provided by a control module 106. In accordance with the present disclosure, each of the model faces stored in database 104 may correspond to face shape and/or texture data in the form of one or more Principal Component Analysis (PCA) coefficients. Morphable face model 102 may be derived by transforming shape and/or texture data provided by database 104 into a vector space representation.

As will be explained in greater detail, below, model 102 may learn a morphable model face in response to faces in database 104 where the morphable face may be represented as a linear combination of a mean face with PCA eigen-values and eigen-vectors. As will also be explained in greater detail below, control module 106 may include a user interface (UI) 108 providing one or more facial feature controls (e.g., sliders) that may be configured to control the output of model 102.

In various implementations, model 102 and control module 106 of system 100 may be provided by one or more software applications executing on one or more processor cores of a computing system while one or more storage devices (e.g., physical memory devices, disk drives and the like) associated with the computing system may provide database 104. In other implementations, the various components of system 100 may be distributed geographically and communicatively coupled together using any of a variety of wired or wireless networking techniques so that database 104 and/or control module 106 may be physically remote from model 102. For instance, one or more servers remote from model 102 may provide database 104 and face data may be communicated to model 102 over, for example, the internet. Similarly, at least portions of control module 106, such as UI 108, may be provided by an application in a web browser of a computing system, while model 102 may be hosted by one or more servers remote to that computing system and coupled to module 106 via the internet.

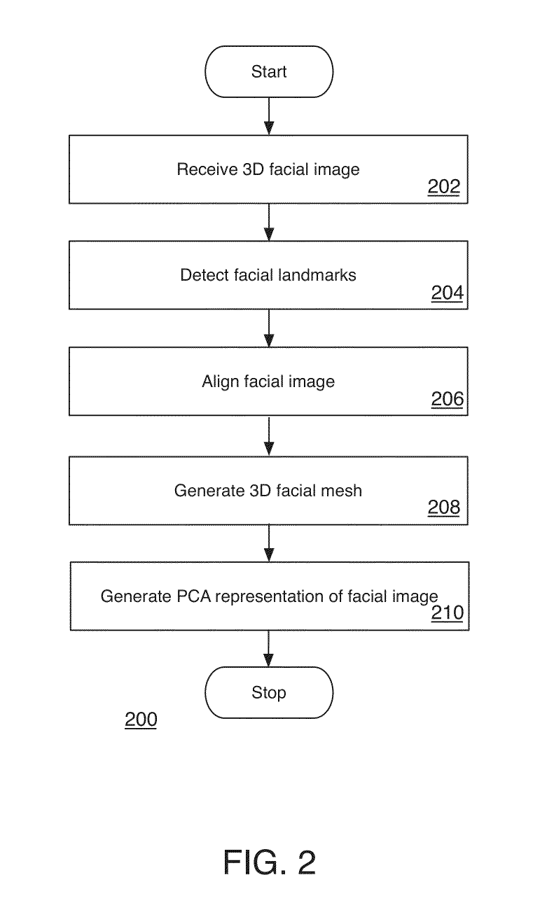

FIG. 2 illustrates a flow diagram of an example process 200 for generating model faces according to various implementations of the present disclosure. In various implementations, process 200 may be used to generate a model face to be stored in a database such as database 104 of system 100. Process 200 may include one or more operations, functions or actions as illustrated by one or more of blocks 202, 204, 206, 208 and 210 of FIG. 2. By way of non-limiting example, process 200 will be described herein with reference to example system of FIG. 1. Process 200 may begin at block 202.

At block 202, a 3D facial image may be received. For example, block 202 may involve receiving data specifying a face in terms of shape data (e.g., x, y, z in terms of Cartesian coordinates) and texture data (e.g., red, green and blue color in 8-bit depth) for each point or vertice of the image. For instance, the 3D facial image received at block 202 may have been generated using known techniques such as laser scanning and the like, and may include thousands of vertices. In various implementations, the shape and texture of a facial image received at block 202 may be represented by column vectors S=(x₁, y₁, z₁, x₂, y₂, z₂, . . . , xₙ, yₙ, zₙ)^{t}, and T=(R₁, G₁, B₁, R₂, G₂, B₂, . . . , Rₙ, Gₙ, Zₙ)^{t}, respectively (where n is the number of vertices of a face).

At block 204, predefined facial landmarks of the 3D image may be detected or identified. For example, in various implementations, known techniques may be applied to a 3D image to extract landmarks at block 204 (for example, see Wu and Trivedi, “Robust facial landmark detection for intelligent vehicle system”, International Workshop on Analysis and Modeling of Faces and Gestures, October 2005). In various implementations, block 204 may involve identifying predefined landmarks and their associated shape and texture vectors using known techniques (see. e.g., Zhang et al., “Robust Face Alignment Based On Hierarchical Classifier Network”, Proc. ECCV Workshop Human-Computer Interaction, 2006, herein after Zhang) For instance, Zhang utilizes eight-eight (88) predefined landmarks, including, for example, eight predefined landmarks to identify an eye.

At block 206, the facial image (as specified by the landmarks identified at block 204) may be aligned, and at block 208 a mesh may be formed from the aligned facial image. In various implementations, blocks 206 and 208 may involve applying known 3D alignment and meshing techniques (see, for example, Kakadiaris et al “3D face recognition”, Proc. British Machine Vision Conf., pages 200-208 (2006)). In various implementations, blocks 206 and 208 may involve aligning the facial image's landmarks to a specific reference facial mesh so that a common coordinate system may permit any number of model faces generated by process 200 to be specified in terms of shape and texture variance of the image's landmarks with respect to the reference face.

Process 200 may conclude at block 210, where PCA representations of the aligned facial image landmarks may be generated. In various implementations, block 210 may involve using known techniques (see, for example, M. A. Turk and A. P. Pentland, “Face Recognition Using Eigenfaces”, IEEE Conf. on Computer Vision and Pattern Recognition, pp. 586-591, 1991) to represent the facial image as

$$X = {X}_{0} + {\sum }_{i = 1}^{n} {P}_{i} {λ}_{i} \qquad ( 1 )$$

where X₀ corresponds to a mean column vector, Pᵢ is the i^{th} PCA eigen-vector and λᵢ is the corresponding i^{th} eigen-vector value or coefficient.

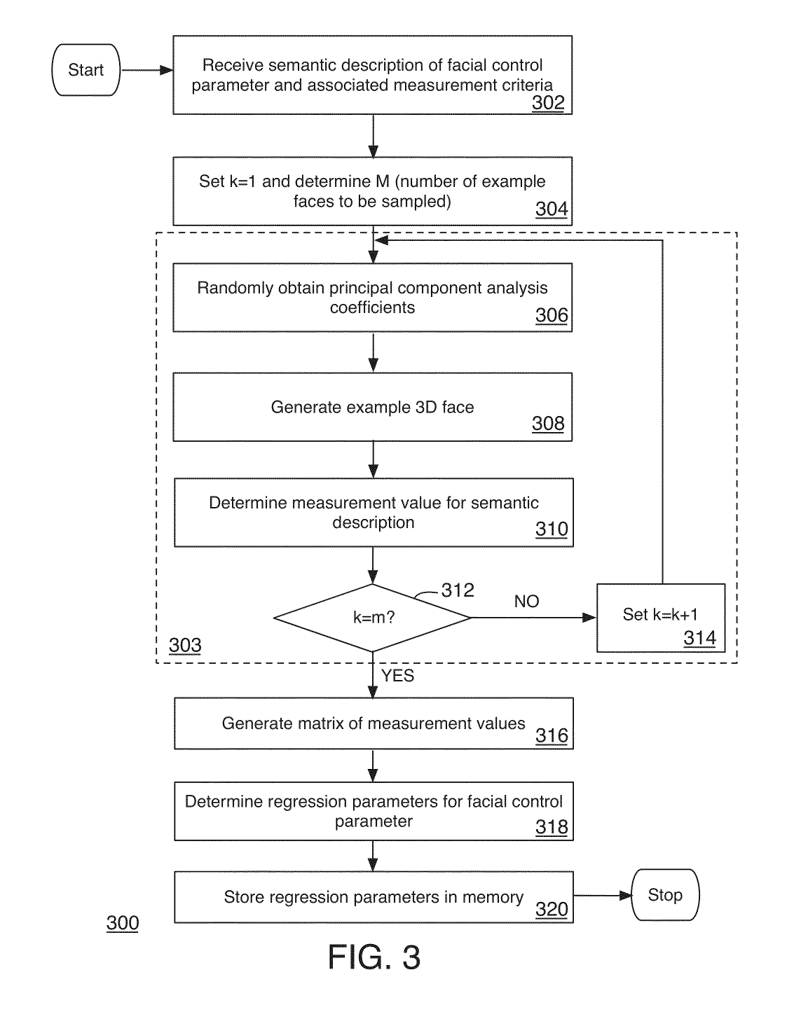

FIG. 3 illustrates a flow diagram of an example process 300 for specifying a facial feature parameter according to various implementations of the present disclosure. In various implementations, process 300 may be used to specify facial feature parameters associated with facial feature controls of control module 106 of system 100. Process 300 may include one or more operations, functions or actions as illustrated by one or more of blocks 302, 304, 306, 308, 310, 312, 314, 316, 318 and 320 of FIG. 3. By way of non-limiting example, process 300 will be described herein with reference to example system of FIG. 1. Process 300 may begin at block 302.

At block 302, a semantic description of a facial control parameter and associated measurement criteria. In various implementations, a semantic description received at block 302 may correspond to any aspect, portion or feature of a face such as, for example, age (e.g., ranging from young to old), gender (e.g., ranging from female to male), shape (e.g., oval, long, heart, square, round, triangular and diamond); ethnicity (e.g., east Asian, Asian sub-continent, white, etc); expression (e.g., angry, happy, surprised, etc.). In various implementations, corresponding measurement criteria received at block 302 may include deterministic and/or discrete measurement criteria. For example, for a gender semantic description the measurement criteria may be male or female. In various implementations, corresponding measurement criteria received at block 302 may include numeric and/or probabilistic measurement criteria, such as face shape, eye size, nose height, etc, that may be measured by specific key points.

Process 300 may then continue with the sampling of example faces in PCA space as represented by loop 303 where, at block 304, an index k may be set to 1 and a total number m of example faces to be sampled may be determined for loop 303. For instance, it may be determined that for a facial control parameter description received at block 302, a total of m=100 example faces may be sampled to generate measurement values for the facial control parameter. Thus, in this example, loop 303, as will be described in greater detail below, may be undertaken a total of a hundred times to generate a hundred example faces and a corresponding number of measurement values for the facial control parameter.

At block 306, PCA coefficients may be randomly obtained and used to generate an example 3D face at block 308. The 3D face generated at block 308 may then be represented by

$$X = {X}_{0} + {\sum }_{i = 1}^{n} {α}_{i} {P}_{i} {λ}_{i} \qquad ( 2 )$$

where αᵢ is the coefficient for the i^{th} eigen-vector.

In various implementations, block 306 may include sampling a set of coefficients {αᵢ}corresponding to the first-n dimension eigen-values representing about 95% of the total energy in PCA space. Sampling in a PCA sub-space instead of the entire PCA space at block 306 may permit characterization of the measurement variance for the entire PCA space. For example, sampling PCA coefficients in the range of {αᵢ}=[−3, +3] may correspond to sampling the i^{th} eigen-value in the range of [−3*λᵢ, +3*λᵢ] corresponding to data variance in the range of [−3*std, +3*std](where “std” represents standard deviation).

At block 310, a measurement value for the semantic description may be determined. In various implementations, block 310 may involve calculating a measurement value using coordinates of various facial landmarks. For instance, setting the i^{th} sampled eigen-values coefficients to be Ai={aᵢⱼ, j=1, . . . n}, the corresponding measurement, representing the likelihood with respect to a representative face at block 310 may be designated B_{k×1}.

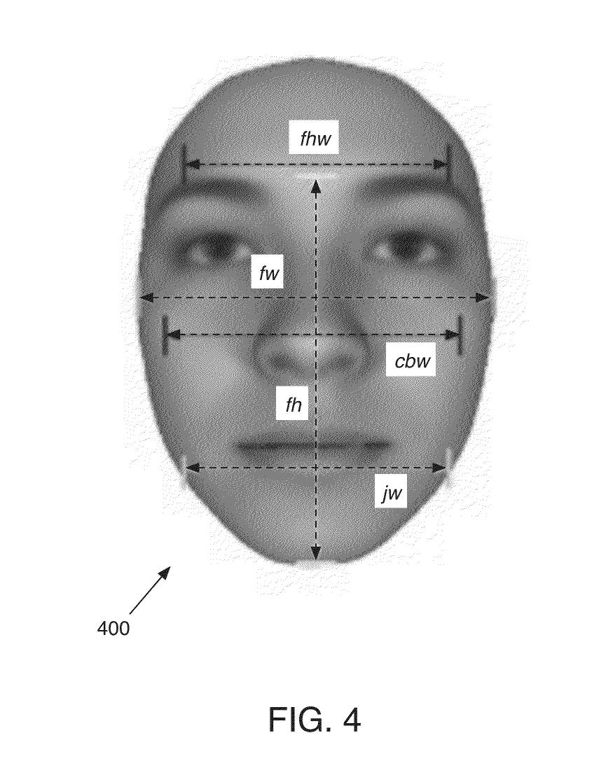

In various implementations, each of the known semantic face shapes (oval, long, heart, square, round, triangular and diamond) may be numerically defined or specified by one or more facial feature measurements. For instance, FIG. 4 illustrates several example metric measurements for an example mean face 400 according to various implementations of the present disclosure. As shown, metric measurements used to define or specify facial feature parameters corresponding to semantic face shapes may include forehead-width (fhw), cheekbone-width (cbw), jaw-width (jw), face-width (fw), and face-height (fh). In various implementations, representative face shapes may be defined by one or more Gaussian distributions of such feature measurements and each example face may be represented by the corresponding probability distribution of those measurements.

Process 300 may continue at block 312 with a determination of whether k=nm. For example, for m=100, a first iteration of blocks 306-310 of loop 303 corresponds to k=1, hence km at block 312 and process 300 continues at block 314 with the setting of k=k+1 and the return to block 306 where PCA coefficients may be randomly obtained for a new example 3D face. If, after, one or more additional iterations of blocks 306-310, k=m is determined at block 312, then loop 303 may end and process 300 may continue at block 316 where a matrix of measurement values may be generated for the semantic description received at block 302.

In various implementations, block 316 may include normalizing the set of m facial control parameter measurements to the range [−1, +1] and expressing the measurements as

A_{m×n}=B_{m×1}·R_{1×n} (3)

where A_{m×n} is a matrix of sampled eigen-value coefficients, in which each row corresponds to one sample, each row in measurement matrix B_{m×1} corresponds to the normalized control parameter, and regression matrix R_{1×n} maps the facial control parameter to coefficients of eigen-values. In various implementations, a control parameter value of b=0 may correspond to an average value (e.g., average face) for the particular semantic description, and b=1 may correspond to a maximum positive likelihood for that semantic description. For example, for a gender semantic description, a control parameter value of b=0 may correspond to a gender neutral face, b=1 may correspond to a strongly male face, b=−1 may correspond to a strongly female face, and a face with a value of, for example, b=0.8, may be more male than a face with a value of b=0.5.

Process 300 may continue at block 318 where regression parameters may be determined for the facial control parameter. In various implementations, block 318 may involve determining values of regression matrix R_{1×n} of Eq. (3) according to

R_{1×n}=(B^{T}·B)⁻¹·B^{T}·A (4)

where B^{T} is the transpose of measurement matrix B. Process 300 may conclude at block 320 with storage of the regression parameters in memory for later retrieval and use as will be described in further detail below.

In various implementations, process 300 may be used to specify facial control parameters corresponding to the well recognized semantic face shapes of oval, long, heart, square, round, triangular and diamond. Further, in various implementations, the facial control parameters defined by process 300 may be manipulated by feature controls (e.g., sliders) of UI 108 enabling users of system 100 to modify or customize the output of facial features of 3D morphable face model 102. Thus, for example, facial shape control elements of UI 108 may be defined by undertaking process 300 multiple times to specify control elements for oval, long, heart, square, round, triangular and diamond facial shapes.

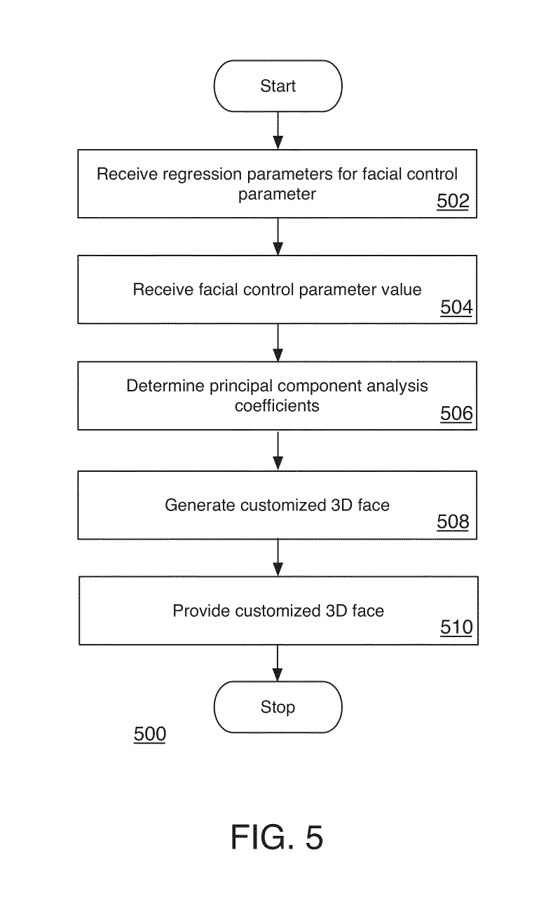

FIG. 5 illustrates a flow diagram of an example process 500 for generating a customized 3D face according to various implementations of the present disclosure. In various implementations, process 500 may be implemented by 3D morphable face model 102 in response to control module 106 of system 100. Process 500 may include one or more operations, functions or actions as illustrated by one or more of blocks 502, 504, 506, 508 and 510 of FIG. 5. By way of non-limiting example, process 500 will be described herein with reference to example system of FIG. 1. Process 500 may begin at block 502.

At block 502, regression parameters for a facial control parameter may be received. For example, block 502 may involve model 102 receiving regression parameters R_{1×n} of Eq. (3) for a particular facial control parameter such as a gender facial control parameter or square face shape facial control parameter, to name a few examples. In various implementations, the regression parameters of block 502 may be received from memory. At block 504, a value for the facial control parameter may be received and, at block 506, PCA coefficients may be determined in response to the facial control parameter value. In various implementations, block 504 may involve receiving a facial control parameter b represented, for example, by B_{I×1} (for m−1), and block 506 may involve using the regression parameters R_{1×n} to calculate the PCA coefficients as follows

A_{1×n}=B_{1×1}·R_{1×n} (5)

Process 500 may continue at block 508 where a customized 3D face may be generated based on the PCA coefficients determined at block 508. For example, block 508 may involve generating a face using Eq. (2) and the results of Eq. (5). Process 300 may conclude at block 510 where the customized 3D face may be provided as output. For instance, blocks 508 and 510 may be undertaken by face model 102 as described herein.

While the implementation of example processes 200, 300 and 500, as illustrated in FIGS. 2, 3 and 5, may include the undertaking of all blocks shown in the order illustrated, the present disclosure is not limited in this regard and, in various examples, implementation of processes 200, 300 and/or 500 may include the undertaking only a subset of all blocks shown and/or in a different order than illustrated.

In addition, any one or more of the processes and/or blocks of FIGS. 2, 3 and 5 may be undertaken in response to instructions provided by one or more computer program products. Such program products may include signal bearing media providing instructions that, when executed by, for example, one or more processor cores, may provide the functionality described herein. The computer program products may be provided in any form of computer readable medium. Thus, for example, a processor including one or more processor core(s) may undertake one or more of the blocks shown in FIGS. 2, 3 and 5 in response to instructions conveyed to the processor by a computer readable medium.

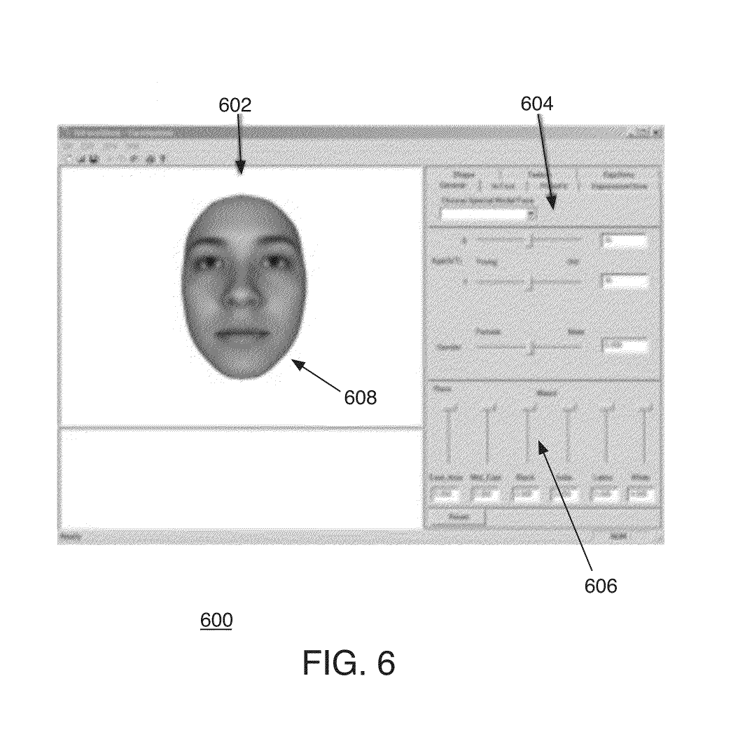

FIG. 6 illustrates an example user interface (UI) 600 according to various implementations of the present disclosure. For example, UI 600 may be employed as UI 108 of system 100. As shown, UI 600 includes a face display pane 602 and a control pane 604. Control pane 604 includes feature controls in the form of sliders 606 that may be manipulated to change the values of various corresponding facial control parameters. Various facial features of a simulated 3D face 608 in display pane 602 may be customized in response to manipulation of sliders 606. In various implementations, various control parameters of UI 600 may be adjusted by manual entry of parameter values. In addition, different categories of simulation (e.g., facial shape controls, facial ethnicity controls, and so forth) may be clustered on different pages control pane 604. In various implementations, UI 600 may include a different feature control, such as a slider, configured to allow a user to separately control different facial shapes. For example, UI 600 may include seven distinct sliders for independently controlling oval, long, heart, square, round, triangular and diamond facial shapes.

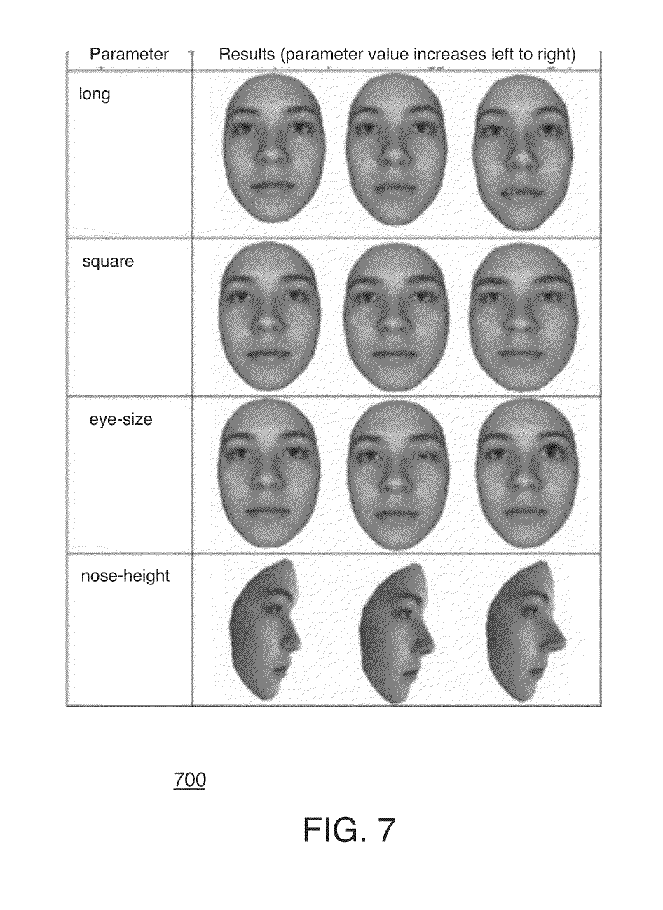

FIGS. 7-9 illustrates example facial control parameter schemes according to various implementations of the present disclosure. Undertaking the processes described herein may provide the schemes of FIGS. 7-10. In various implementations, specific portions of face such as eye, chin, nose, and so forth, may be manipulated independently. FIG. 7 illustrates example scheme 700 including facial control parameters for a long face shape and a square face shape as well as more discrete facial control parameters permitting modification, for example, of portions of a face such eye size and nose height.

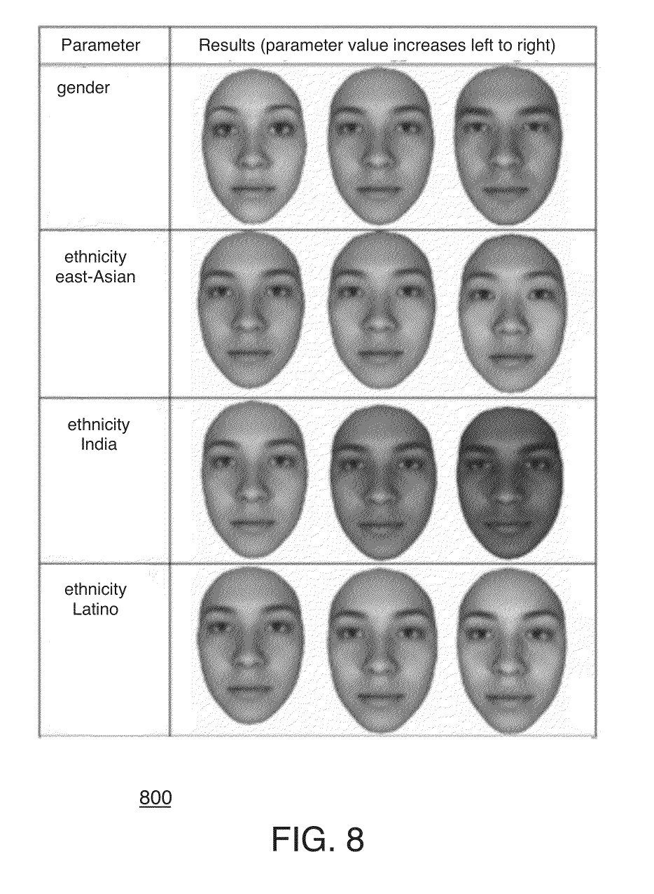

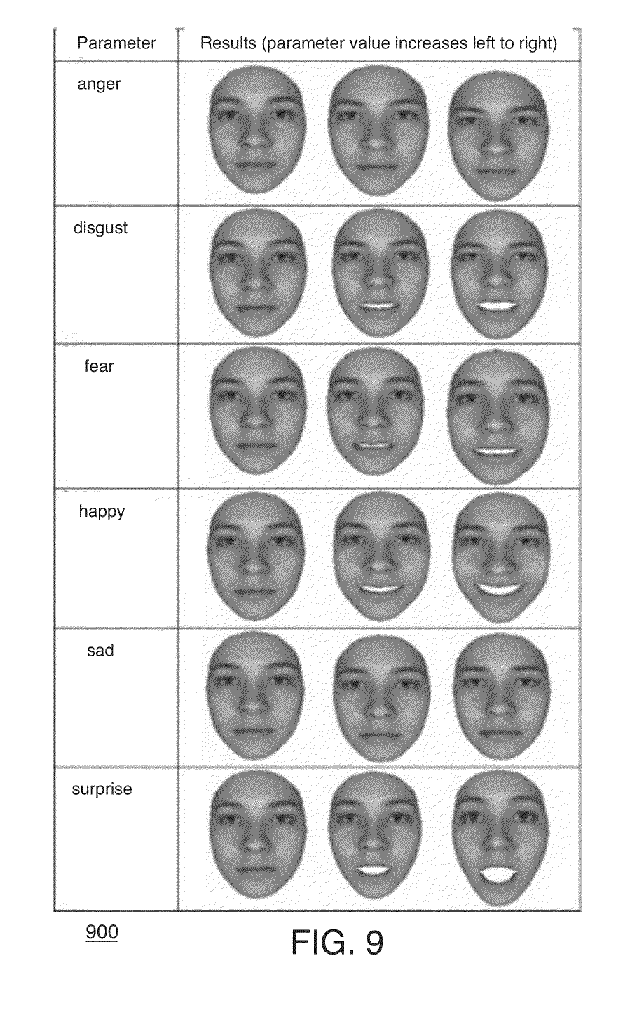

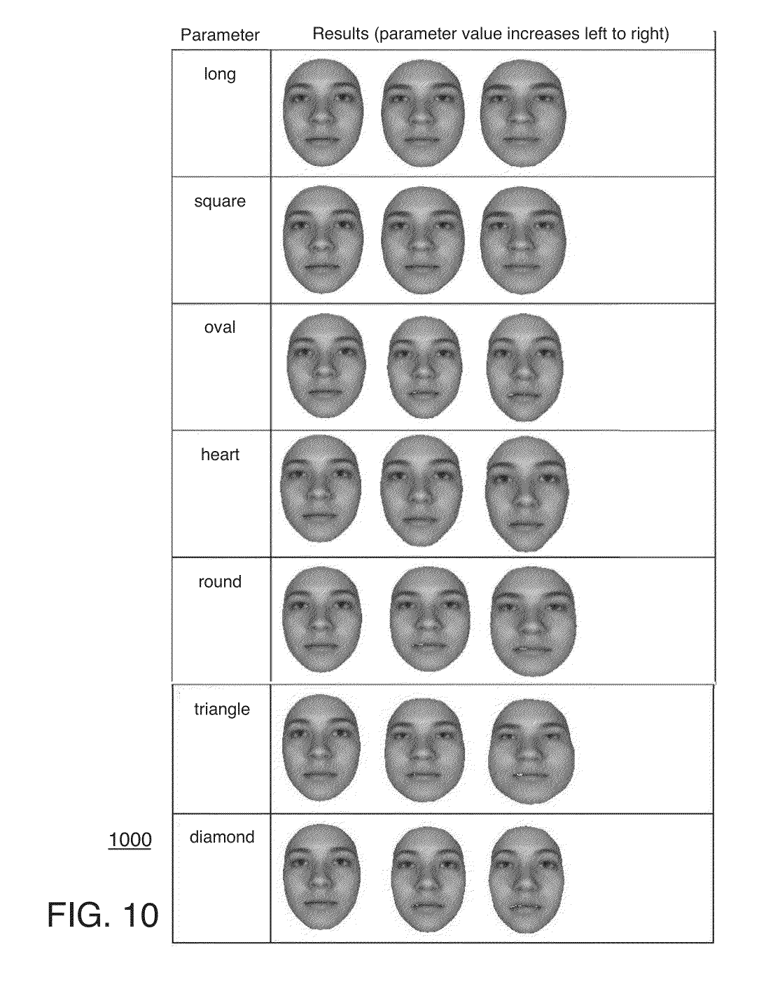

For another non-limiting example, FIG. 8 illustrates example scheme 800 including facial control parameters for gender and ethnicity where face shape and texture (e.g., face color) may be manipulated or customized. In various implementations, some controls (e.g., gender) parameter values may have the range [−1, +1], while others such as ethnicities may range from zero (mean face) to −1. In yet another non-limiting example, FIG. 9 illustrates example scheme 900 including facial control parameters for facial expression including anger, disgust, fear, happy, sad and surprise may be manipulated or customized. In various implementations, expression controls may range from zero (mean or neural face) to +1. In some implementations an expression control parameter value may be increased beyond +1 to simulate an exaggerated expression FIG. 10 illustrates example scheme 1000 including facial control parameters for a long, square, oval, heart, round, triangle and diamond face shapes.

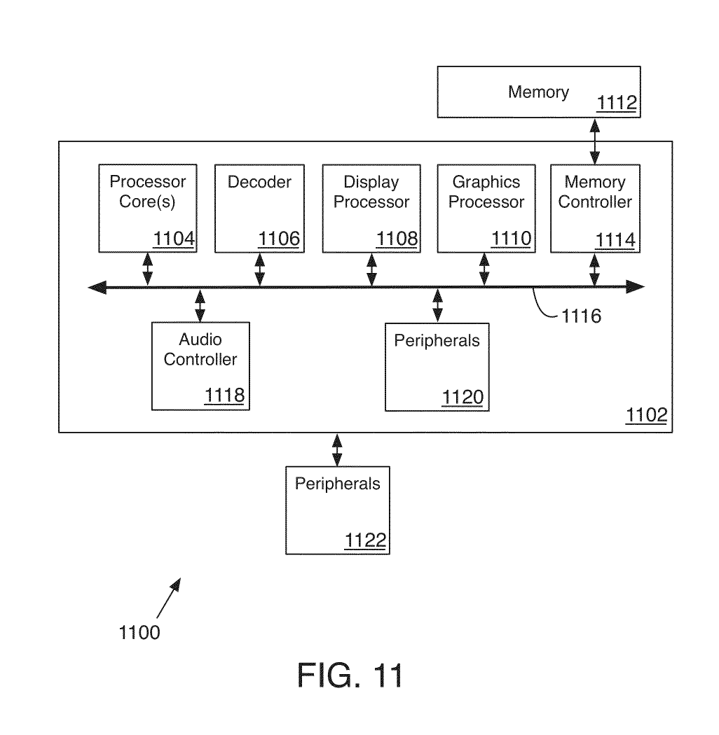

FIG. 11 illustrates an example system 1100 in accordance with the present disclosure. System 1100 may be used to perform some or all of the various functions discussed herein and may include any device or collection of devices capable of undertaking parameterized 3D face generation in accordance with various implementations of the present disclosure. For example, system 1100 may include selected components of a computing platform or device such as a desktop, mobile or tablet computer, a smart phone, a set top box, etc., although the present disclosure is not limited in this regard. In some implementations, system 1100 may be a computing platform or SoC based on Intel® architecture (IA) for CE devices. It will be readily appreciated by one of skill in the art that the implementations described herein can be used with alternative processing systems without departure from the scope of the present disclosure.

System 1100 includes a processor 1102 having one or more processor cores 1104. Processor cores 1104 may be any type of processor logic capable at least in part of executing software and/or processing data signals. In various examples, processor cores 1104 may include CISC processor cores, RISC microprocessor cores, VLIW microprocessor cores, and/or any number of processor cores implementing any combination of instruction sets, or any other processor devices, such as a digital signal processor or microcontroller.

Processor 1102 also includes a decoder 1106 that may be used for decoding instructions received by, e.g., a display processor 1108 and/or a graphics processor 1110, into control signals and/or microcode entry points. While illustrated in system 1100 as components distinct from core(s) 1104, those of skill in the art may recognize that one or more of core(s) 1104 may implement decoder 1106, display processor 1108 and/or graphics processor 1110. In some implementations, processor 1102 may be configured to undertake any of the processes described herein including the example processes described with respect to FIGS. 2, 3 and 5. Further, in response to control signals and/or microcode entry points, decoder 1106, display processor 1108 and/or graphics processor 1110 may perform corresponding operations.

Processing core(s) 1104, decoder 1106, display processor 1108 and/or graphics processor 1110 may be communicatively and/or operably coupled through a system interconnect 1116 with each other and/or with various other system devices, which may include but are not limited to, for example, a memory controller 1114, an audio controller 1118 and/or peripherals 1120. Peripherals 1120 may include, for example, a unified serial bus (USB) host port, a Peripheral Component Interconnect (PCI) Express port, a Serial Peripheral Interface (SPI) interface, an expansion bus, and/or other peripherals. While FIG. 11 illustrates memory controller 1114 as being coupled to decoder 1106 and the processors 1108 and 1110 by interconnect 1116, in various implementations, memory controller 1114 may be directly coupled to decoder 1106, display processor 1108 and/or graphics processor 1110.

In some implementations, system 1100 may communicate with various I/O devices not shown in FIG. 11 via an I/O bus (also not shown). Such I/O devices may include but are not limited to, for example, a universal asynchronous receiver/transmitter (UART) device, a USB device, an I/O) expansion interface or other I/O devices. In various implementations, system 1100 may represent at least portions of a system for undertaking mobile, network and/or wireless communications.

System 1100 may further include memory 1112. Memory 1112 may be one or more discrete memory components such as a dynamic random access memory (DRAM) device, a static random access memory (SRAM) device, flash memory device, or other memory devices. While FIG. 11 illustrates memory 1112 as being external to processor 1102, in various implementations, memory 1112 may be internal to processor 1102. Memory 1112 may store instructions and/or data represented by data signals that may be executed by processor 1102 in undertaking any of the processes described herein including the example processes described with respect to FIGS. 2, 3 and 5. For example, memory 1112 may store regression parameters and/or PCA coefficients as described herein. In some implementations, memory 1112 may include a system memory portion and a display memory portion.

The devices and/or systems described herein, such as example system 100 and/or UI 600 represent several of many possible device configurations, architectures or systems in accordance with the present disclosure. Numerous variations of systems such as variations of example system 100 and/or UI 600 are possible consistent with the present disclosure.

The systems described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1-30. (canceled)

31. A computer-implemented method, comprising:
receiving a semantic description and associated measurement criteria for a facial control parameter;
obtaining a plurality of principal component analysis (PCA) coefficients;
generating a plurality of 3D faces in response to the plurality of PCA coefficients;
determining a measurement value for each of the plurality of 3D faces in response to the measurement criteria; and
determining a plurality of regression parameters for the facial control parameter in response to the measurement values.

32. The method of claim 31, wherein obtaining the plurality of PCA coefficients comprises randomly obtaining the PCA coefficients from memory.

33. The method of claim 31, wherein the semantic description comprises a semantic description of a facial shape.

34. The method of claim 31, further comprising:
storing the plurality of regression parameters in memory.

35. The method of claim 34, wherein the plurality of regression parameters includes first regression parameters, the method further comprising:
receiving the first regression parameters from the memory;
receiving a value of the facial control parameter;
determining first PCA coefficients in response to the value, wherein the plurality of PCA coefficients includes the first PCA coefficients; and
generating a 3D face in response to the first PCA coefficients.

36. The method of claim 35, wherein the value of the facial control parameter comprises a value of the facial control parameter generated in response to manipulation of a feature control.

37. The method of claim 36, wherein the feature control comprises one of a plurality of facial shape controls.

38. The method of claim 37, wherein the plurality of facial shape controls comprises separate features controls corresponding to each of a long facial shape, an oval facial shape, a heart facial shape, a square facial shape, a round facial shape, a triangular facial shape, and a diamond facial shape.

39. A computer-implemented method, comprising:
receiving regression parameters for a facial control parameter;
receiving a value of the facial control parameter;
determining principal component analysis (PCA) coefficients in response to the value; and
generating a 3D face in response to the PCA coefficients.

40. The method of claim 39, wherein the value of the facial control parameter comprises a value of the facial control parameter generated in response to manipulation of a feature control.

41. The method of claim 40, wherein the feature control comprises one of a plurality of facial shape controls.

42. The method of claim 41, wherein the plurality of facial shape controls comprises separate features controls corresponding to each of a long facial shape, an oval facial shape, a heart facial shape, a square facial shape, a round facial shape, a triangular facial shape, and a diamond facial shape.

43. A system, comprising:
a processor and a memory coupled to the processor, wherein instructions in the memory configure the processor to:
receive regression parameters for a facial control parameter;
receive a value of the facial control parameter;
determine principal component analysis (PCA) coefficients in response to the value; and
generate a 3D face in response to the PCA coefficients.

44. The system of claim 43, further comprising a user interface, wherein the user interface includes a plurality of feature controls, and wherein the instructions in the memory configure the processor to receive the value of the facial control parameter in response to manipulation of a first feature control of the plurality of feature controls.

45. The system of claim 43, wherein the plurality of feature controls comprise a plurality of facial shape controls.

46. The system of claim 45, wherein the plurality of facial shape controls comprises separate features controls corresponding to each of a long facial shape, an oval facial shape, a heart facial shape, a square facial shape, a round facial shape, a triangular facial shape, and a diamond facial shape.

47. An article comprising a computer program product having stored therein instructions that, if executed, result in:
receiving a semantic description and associated measurement criteria for a facial control parameter;
obtaining a plurality of principal component analysis (PCA) coefficients;
generating a plurality of 3D faces in response to the plurality of PCA coefficients;
determining a measurement value for each of the plurality of 3D faces in response to the measurement criteria; and
determining a plurality of regression parameters for the facial control parameter in response to the measurement values.

48. The article of claim 47, wherein obtaining the plurality of PCA coefficients comprises randomly obtaining the PCA coefficients from memory.

49. The article of claim 47, wherein the semantic description comprises a semantic description of a facial shape.

50. The article of claim 47, the computer program product having stored therein further instructions that, if executed, result in:
storing the plurality of regression parameters in memory.

51. The article of claim 50, wherein the plurality of regression parameters includes first regression parameters, the computer program product having stored therein further instructions that, if executed, result in:
receiving the first regression parameters from the memory;
receiving a value of the facial control parameter;
determining first PCA coefficients in response to the value, wherein the plurality of PCA coefficients includes the first PCA coefficients; and
generating a 3D face in response to the first PCA coefficients.

52. The article of claim 51, wherein the value of the facial control parameter comprises a value of the facial control parameter generated in response to manipulation of a feature control.

53. The article of claim 52, wherein the feature control comprises a slider.

54. The article of claim 52, wherein the feature control comprises one of a plurality of facial shape controls.

55. The article of claim 54, wherein the plurality of facial shape controls comprises separate features controls corresponding to each of a long facial shape, an oval facial shape, a heart facial shape, a square facial shape, a round facial shape, a triangular facial shape, and a diamond facial shape.
